(19) United States
(12) Patent Application Publication
(10) Pub. No.: US 2008/0141338 A1
(43) Pub. Date: Jun. 12, 2008

(54) SECURE POLICY DESCRIPTION METHOD AND APPARATUS FOR SECURE OPERATING SYSTEM

(76) Inventors: Dong Wook KIM, Seoul (KR); Kang Ho KIM, Daejeon (KR); Baik Song AN, Daejeon (KR); Sung In JUNG, Daejeon (KR); Myung Joon KIM, Daejeon (KR); Bong Nam NOH, Gwangju (KR); Jung Sun KIM, Gwangju (KR); Min Soo KIM, Gwangju (KR); Jong Min JUNG, Bosung-gun (KR)

Correspondence Address: LADAS & PARRY LLP, 224 SOUTH MICHIGAN AVENUE, SUITE 1600, CHICAGO, IL, 60604, US

(21) Appl. No.: 11/769,221

(22) Filed: Jun. 27, 2007

(30) Foreign Application Priority Data
Dec. 7, 2006 (KR) 10-2006-0123871

(51) Int. Cl. H04L 9/00

(52) U.S. Cl. 726/1

(57) ABSTRACT

A secure policy description method and apparatus for a secure operation system are provided. In the secure policy description method, a secure policy template is defined to have a subject, an object, and a permission assigned to the subject corresponding to the object. Then, the defined secure policy template is transformed to a TE (Type Enforcement) secure policy to be applied to a SELinux (Security enhanced Linux).

### CLAIM OF PRIORITY

This application claims the benefit of Korean Patent Application No. 10-2006-123871 filed on Dec. 7, 2006 in the Korean Intellectual Property Office, the disclosure of which is incorporated herein by reference.

### BACKGROUND OF THE INVENTION

1. Field of the Invention

The present invention relates to a secure policy description method and apparatus for a secure operating system, and more particularly, to a secure policy description method and apparatus for a secure operation system in order to enable a user having no expert knowledge to easily set a secure policy.

2. Description of the Related Art

As the Internet environment has been advanced, a user has become capable of accessing computers and networks distributed in a world wide range and using information thereof. Although the advanced Internet environment maximizes the convenience of using information, the advanced Internet environment has been suffered for security issues. That is, sensitive data is opened to unauthorized users or frequently receives malicious attacks in the Internet environment.

In order to share and use information safe, application level security technologies such as encryption, a firewall, and an intrusion detection system have been introduced. These introduced application level security technologies protect the information of networks and servers. The application level security technologies, however, have vulnerabilities to confront insider intrusion, permission misuse, and system hacking.

In order to overcome such problems and implement a trusted computed base (TCB) environment, there are many researches in progress for developing a secure operating system. A security enhanced Linux (SELinux) is one of representative secure operating systems.

The SELinux is a secure operating system developed by applying Flux Advanced Security Kernel (Flask) from NSA to Linux. Such a SELinux provides a structure executing various access control polices such as type enforcement (TE), role based access control, and a multi-level security (MLS). The SELinux also performs access control operations for various system resources such as processes, signals, and memories. Furthermore, the SELinux minimizes a damage range and prevents malicious code from executing through allocating minimum permission. Structurally, a policy deciding module is separated from a policy executing module in the SELinux, thereby providing flexibility of secure policy.

In order to control each process to be operated within a minimum permission in an own domain and not to influence other process domains, the SELinux has a secure police constituted as a TE model shown in FIG. 1. Hereinafter, a subject denotes a security object corresponding to a performer who performs a permitted operation or requests a target object to access. An object denotes a security object corresponding to a target of the subject to perform a related operation. That is, available resources can be object.

Referring to FIG. 1, in the SELinux, all subjects and objects are allocated with a type which denotes a group having the same secure property. Herein, a type assigned to a subject is a domain. If a subject having a predetermined type creates an object or if an object having a predetermined type is executed, the type transits to a type defined in a policy.

Although the SELinux provides delicate access controls, the SELinux, however, has a drawback of increasing the complexity of a secure policy because the subject-object relation is expressed through a type and the subject-object relation changes through the type transition.

For example, a strict policy defined in a fedora core 4, which is a linux package widely used, has 1341 types and more than four million rules defining relations between the types. The conventional secure polices formed of numerous types and rules are too difficult to a user to read and modify, and there is a great probability to occur conflict problems to conventional rules and types. Therefore, it is very difficult to a normal user to set a secure policy to be suitable to the purpose thereof.

### SUMMARY OF THE INVENTION

The present invention has been made to solve the foregoing problems of the prior art and therefore an aspect of the present invention is to provide a secure policy description method and apparatus for a secure operating system in order to enable a user with no expert knowledge to easily set a secure policy.

According to an aspect of the invention, the invention provides a secure policy description method for a secure operating system including: defining a secure policy template formed of a subject, an object, and a permission assigned to the subject corresponding to the object; and transforming the defined secure policy template to a TE (Type Enforcement) secure policy to be applied to a SELinux (security enhanced linux).

The defining the secure policy template may comprise: describing a template name to identify a secure policy template; describing a subject element as a low level element of the secure policy template to define a subject accessing an object; describing an object element as a low level element of the secure policy template to define at least one of objects as a target to access by the subject defined in the subject element; and describing a permission element to define an access permission between the subject and the objects, which are defined in the subject element and the object element.

According to another aspect of the invention for realizing the object, there is provided a secure policy description apparatus including: a secure policy template constituted as a form to set a subject, an object, and a permission assigned to the subject for the object; and a transform module for transforming the secure policy template to a TE (Type Enforcement) secure policy to be applied to a SELinux (secure enhanced Linux).

The secure policy template may comprise low level elements including a subject element for defining a subject accessing an object, an object element for defining at least one of objects as a target to access by the subject defined in the subject element, and a permission element for defining an access permission between the subject and the objects, which are defined in the subject element and the object element. The secure policy template may further comprise at least one of transition elements for defining domain transition.

The transform module may comprise: a parsing unit for parsing the secure policy template; and a generating unit for generating at least one of a subject domain, domain transition, an object type, and a TE operation from the parsed data, and generating a TE context by combining the generated subject domain, domain transition, an object type, or TE operation.

The parsing unit may comprise: a detector for detecting whether an object element, a transition element, and a permission element are present in the secure policy template as low level elements or not; and a parser for parsing each of the low level elements if the detector determines that the low level elements are present in the secure policy template.

The generating unit may comprise: a type generator for generating a domain denoting a subject type and an object type; an operation mapper for mapping operations definable in the secure policy template and permissions of a TE policy, receiving an operation parsed from a permission element of a secure policy template and a corresponding object type from the parsing unit, and returning a permission set of a corresponding TE policy; a TE generator for generating a TE secure context by combining the domain and the object type which are generated from the type generator, and the permission set returned from the operation mapper.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a type enforcement (TE) model used to set a secure policy in a SELinux;

FIG. 2 is a block diagram illustrating a secure structure in a SELinux;

FIG. 3 is a diagram illustrating a secure policy template described by a secure policy description method according to an embodiment of the present invention;

FIG. 4 is a flowchart illustrating a procedure of transforming a secure policy template to a TE secure policy in a secure policy description method according to an embodiment of the present invention; and

FIG. 5 is a block diagram illustrating a secure policy description apparatus according to an embodiment of the present invention.

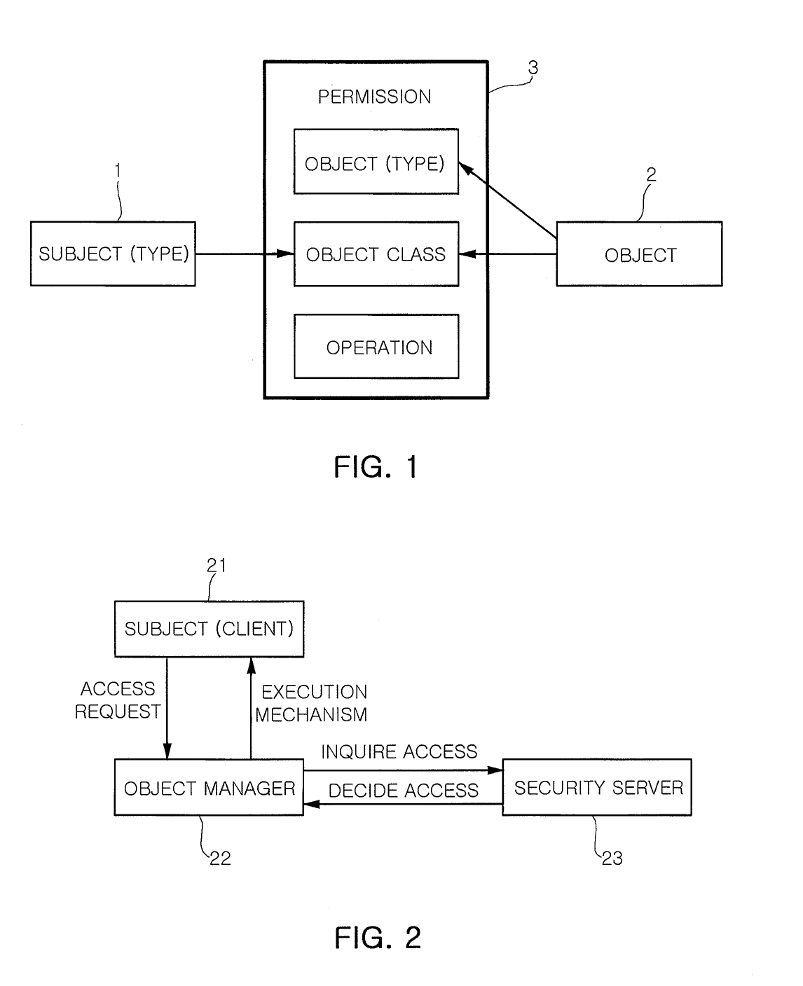

### DETAILED DESCRIPTION OF THE PREFERRED EMBODIMENT

Certain embodiments of the present invention will now be described in detail with reference to the accompanying drawings In order to clearly describe the present invention, the descriptions of well-known functions and elements are omitted. Like numeral references denote like element throughout the accompanying drawings.

It will be understood that when an element is referred to as being “connected” to the other element, it can be directly connected to the other element or it can be electrically connected with an element interleaved there between.

Throughout the specification, a module denotes a unit of a predetermined function or processing a predetermined operation. The module can be embodied as hardware, software, or combination thereof.

FIG. 2 is a block diagram illustrating a structure of a secure operating system where a secure policy description method and apparatus according to the present invention are applied. Particularly, FIG. 2 shows a secure structure of a SELinux.

Referring to FIG. 2, the SELinux comprises an object manager 22 and a security server 23. The security server 23 decides a secure policy according to a selected secure policy model, and the object manager 22 inquires the security server 23 to access a predetermined object. If the object manager 22 receives the decision of accessing the target object, the object manager 22 executes a related policy.

The present invention relates to a method and apparatus for describing a secure policy in the security server 33 having the described structure. The method and apparatus according to the certain embodiments of the present invention can be applied into the security server 23 or implemented as an independent apparatus.

In more detail, the present invention relates to a SELinux template (SELT) for enabling a user to easily use and particularly, to a method and apparatus for describing the secure policy template and transforming the secure policy template to a TE secure policy to apply to the SELinux.

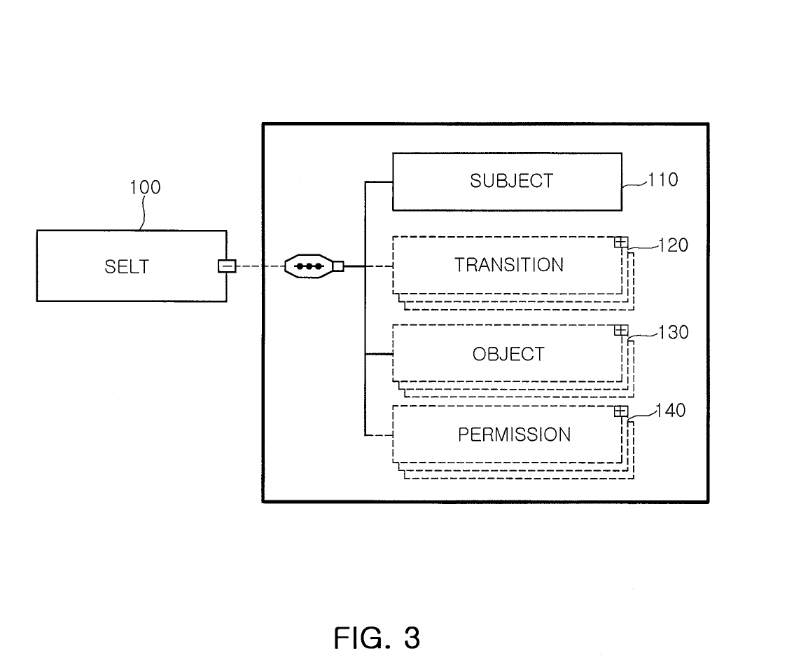

FIG. 3 is a diagram illustrating a secure policy template according to an embodiment of the present invention.

Hereinafter, the structure of a secure policy template according to the present embodiment and a method of setting the same will be described.

Referring to FIG. 3, the policy template element 100 comprises a subject element 110, a transition element 120, an object element 130, and a permission element 140 as low-level elements. The policy template element 100 is stored in a file format, and one secure policy template file describes a policy for one service or one program.

The secure policy template is described as follows.

Template template_name {SUBJECT TRANSITION OBJECT
PERMISSION};

As shown, a key word ‘Template’ is described for starting the secure policy template and a variable ‘template_name’ is the unique name of the secure policy template and used to identify the secure policy template. One secure policy template comprises a subject element SUBJECT, a transition element TRANSITION, an object element OBJECT, and a permission element PERMISSION, as low-level elements.

The subject element SUBJECT 110, the low level element of the secure policy template element 100, is constituted of a user definition of a subject accessing an object and a setting of a target object for domain transition. For example, the subject element (Subject) 110 is described as follows.

Subject:
domain type

As shown, the ‘Subject’ denotes starting of a subject definition. The ‘domain’ assigns a domain name of a subject to define, and the ‘type’ denotes a subject type. The setting of the subject element denotes the setting of the type of the secure policy template element 100. A value assigned to the ‘type’ is a binary or a daemon. The binary denotes the execution of a general application and a daemon denotes a service performed as a daemon type. According to the assigned type value, the basic characteristics of the secure policy template element 100 are decided, and the basic rule thereof changes when the secure policy template is transformed to the TE secure policy.

The transition element 120, the low level element of the secure policy template 100, is a domain that defines transition relation. The transition element 120 is described as follows.

Transition:
domain {object_type}

A keyword ‘Transition’ denotes starting of a transition definition. The ‘domain’ denotes a domain to transit and the ‘object_type’ denotes an object to execute for transition. That is, if a subject corresponding to the domain executes an object corresponding to object_type, it transits to a type defined in the subject element. The transition element can be defined in plural.

The object element 130, the low level element of the secure policy template 100, defines objects to access by a subject defined in the subject element 110. That is, an object type defines the type of an object to access, a forced allocation of a type can be declared through an option value, and the information about the defined object can be provided to an object class. The object element 130 can be described as follows.

Object:
object_type {option} { path_name | value };

As shown, the ‘Object’ denotes starting of object definition. The ‘object_type’ defines the types of objects to access. As object information, the ‘path_name’ is used to assign a path if an object of ‘object_type’ is a file and a directory. If the object is not a file or a directory, a ‘value’ is used to assign necessary value. For example, a ‘value’ has a port number if the object type of a port. Finally, ‘option’ denotes a value representing whether or not the secure context of an object is forcedly allocated. If the ‘option’ is declared as ‘in’, the secure context is forcedly allocated.

The permission element 140, the low level element of the secure policy template 100, describes an access permission between the subject element 110 and the object element 130. Each permission element is set to define what permission to give the subject when the subject accesses an object. The permission element 140 describes a target object, an object type, and permission information. The permission element 140 is described as follows.

Permission:
object_type type { operations, ... }

As shown, the keyword ‘Permission’ denotes starting of permission element definition. The ‘object_type’ denotes a name described in the ‘object_type’ of the described object element 130. In order to express an object with a predetermined type, the ‘type’ is used. The ‘operations’ denotes the access permissions of the subject element 110 for objects having the ‘object_type’ and ‘type’. That is, a subject having the permission of ‘operations’ for an object having the object class of ‘type’. The ‘operations’ can be defined in plural.

For example, a secure policy template according to an embodiment of the present invention, which is created as described above, is shown below.

| 01 Template selt_template { | | |
|---|---|---|
| 02 Subject: | | |
| 03 selt | daemon | |
| 04 Object: | | |
| 05 selt_conf | in | { /etc/security/selt/conf(/.*) } |
| 06 selt_bin | in | { /usr/sbin/selt-converter } |
| 07 selt_template | | |
| { /etc/security/selt/template (/.*) } | | |
| 08 selt_port | | { 1777 } |
| 09 Permission: | | |
| 10 selt_conf | | file { read, write } |
| 11 selt_conf | | dir { access, view } |
| 12 selt_bin | | file { execute } |
| 13 selt_template file { read, write } | | |
| 14 selt_template dir { access, view } | | |
| 15 selt_port | port | { tcp_allow, udp_allow } |
| 16 }; | | |

As shown, the ‘selt_template’ at a line 01 denotes a unique name to identify a corresponding secure policy, and lines 02 and 03 are the definition for the subject element 110. The lines 02 to 03 express that a selt domain is created and the selt domain has a daemon type. Available objects to access in the created selt domain are defined at lines 04 to 08. The defined objects are formed of a file and a network port. The type of access permission between the subject and the object is defined at lines 09 to 15. For example, the permission defined at the line 10 denotes that a read operation and a write operation are permitted to file format objects in a directory /etc/security/selt/conf for an object ‘selt’.

As described above, the secure policy template according to the present embodiment hides the complicated setting, which a TE secure police of a SELinux has, and is constituted of an object, a subject, and a permission (permission) of the subject for the object. Such a simple secure policy template according to the present embodiment has advantages, which allows a user to easily understand and assign to a target permission to any subject. Since the secure policy template according to the present embodiment is described similar to a discretionary access control (DAC), a secure model of a conventional system, it is easy to understand and modify a user defined secure policy template.

Furthermore, types, classes, and permissions, which are used in the secure policy template, are defined by merging types, classes, and permissions, which are defined in the SELinux, and reducing the number thereof. That is, types defined in the SELinux are merged to one type with consideration of relativity and seriality. The various object classes and a plurality of permissions, which are defined in the SELinux, are also merged based on a permission related to various objects, and are simplified by grouping a plurality of permissions into one by analyzing the relativity and seriality of the permissions.

Table 1 illustrating permissions for files and directories among objects applied to the secure policy template, and objects of a SELinux are mapped thereto.

TABLE 1

| | Permissions of secure | |
|---|---|---|
| class | policy template | Permissions defined in SEL inux |
| dir | Create | getattr, setattr, link, create, add_name, |
| | | rename, relabelto, relablefrom |
| | Remove | getattr, unlink, rmdir |
| | Access | getattr, execute |
| | View | search, getattr, read |
| | Mount | mount, remount, unmount, getattr |
| File | Remove | unlink, remove_name |
| | Read | read, getattr, ioctl, lock |
| | Write | write, setattr, append |
| | Execute | getattr, execute |

As shown, the secure policy template according to the present embodiment improves the complexity of the secure policy by grouping and reducing the number of system call level permissions based on the relativity and seriality.

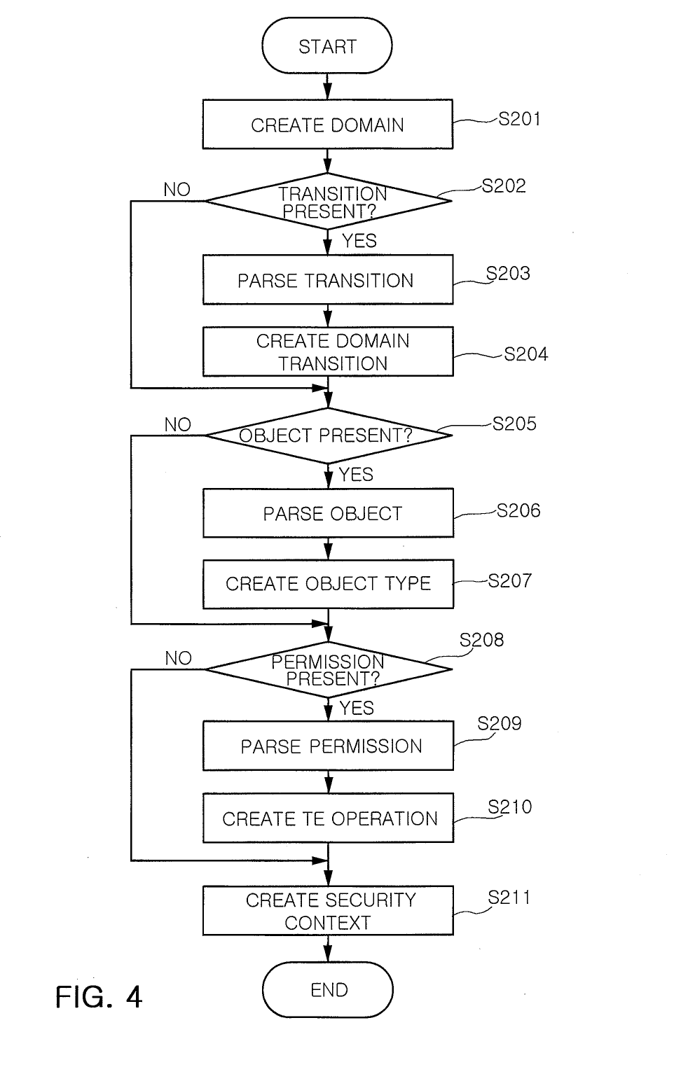

FIG. 4 is a flowchart illustrating a procedure of transforming a secure policy template to a TE secure policy to apply to SELinux.

Referring to FIG. 4, in the secure policy description method according to the present embodiment, a domain is created with reference to a subject element 110 of a defined secure policy template at step S201. The generation of the domain means the declaration of a subject type. At step S201, a type having a minimum permission is declared according to a rule of generating a domain shown in FIG. 3.

Then, the secure policy template is analyzed to determine whether a transition element 120 is present or not at step S202. If the transition element 120 is present, the transition element 120 is parsed at step S203, and a domain transition creating operation is performed at step S204. The secure policy template supports domain transition to be created by an ‘initrc’ daemon during booting, and the domain transition to be created by a manager in a shell state. Therefore, if a domain transition is created while booting, the domain transit creating operation is performed to create transition in an initrc_t domain. If a domain transits in a shell state, the domain transit creating operation is performed to create transition in an unconfined_t domain.

Then, it determines whether an object element 130 is present or not at step S205. If the object element is present, the corresponding object element is parsed and an object type is created at steps S206 and S207. The secure policy template according to the present embodiment supports a network and a file object, including a file and a directory, among the object types of TE secure policy. Therefore, it checks whether the object type is a file or a network when the object element is parsed at step S206. The object type is named using an object_alias of an object indicator, which is set in a rule template description language, like as a domain name assigning method of a subject. At the step of generating an object type, the object type name is assigned using ‘object_type’ described in the object element 130, thereby generating an object type.

Finally, a permission for an object type is created based on the permission element 130 after generating the object type.

In order to create the permission element 140, it determines whether the permission element 140 is defined or not at step S208. If the permission element is present, the permission element is parsed at step S209, the TE operation is created using the parsed permission information at step S210. That is, the TE operation is created by setting a mapping file that maps an operation of a secure policy template to a permission set of a corresponding TE policy and finding the permission set of a secure policy corresponding to the operation of the parsed secure policy template based on the mapping file.

Then, the secure context of the TE policy is created by combining the domain, the domain transition, the object type, and the TE operation at step S211.

The created secure context is applied as the secure context of the objects in defined in the object element of the secure policy template.

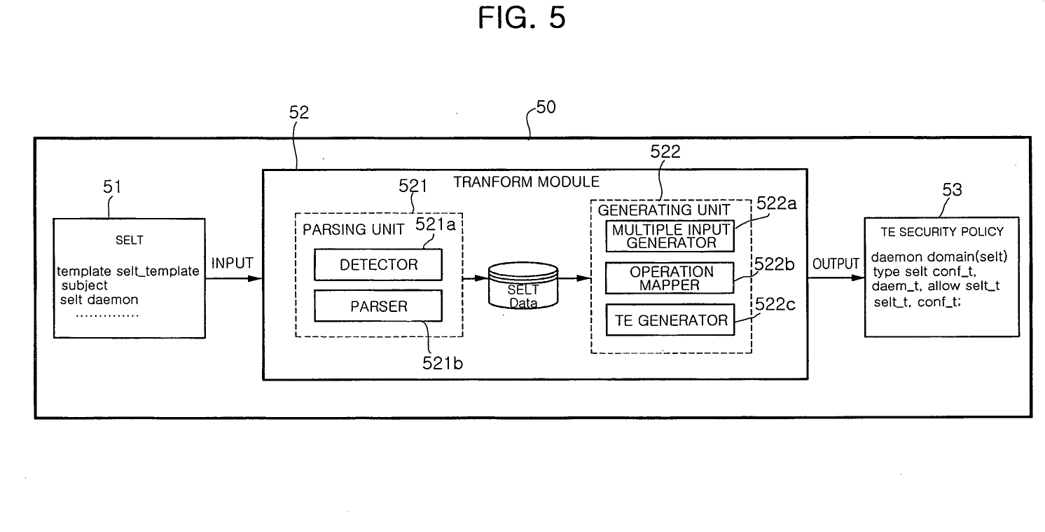

FIG. 5 is a block diagram illustrating a secure policy description apparatus according to an embodiment of the present invention.

Referring to FIG. 5, the secure policy description apparatus according to the present embodiment comprises a secure policy template 51 for setting a subject, an object, and a permission to be assigned to the subject corresponding to the object as described with FIG. 3, and a transform module for transforming the secure policy template to a TE secure policy to be applied to SELinux.

The structure of the secure policy template 51 refers to the description of FIG. 3.

The transform module 52 comprises a parsing unit 521 for parsing the secure policy template 51, and a generating unit 522 for generating a TE context by generating at least one of a subject domain, domain transition, a object type, and a TE operation from the parsed data, and generating a TE context by combining them.

In more detail, the parting unit 521 comprises a detector 521a for determining whether low level elements including an object element, a transition element, and a permission element are present in the secure policy template 51 or not, and a parser 521 for parsing each of the low level elements that are determined as present in the secure policy template. The generating unit 522 comprises a type generator 522a for generating a domain type and an object type, which denote the type of a subject, an operation mapper 522b for mapping operations definable in the secure policy template to the TE policy, receiving the operation type of the secure policy template, and returning a permission set of a TE policy corresponding to the received operation type, and a TE generator 552c for generating a TE secure context by combining the domain and the object type, which are generated from the type generator 522a, and the permission set returned from the operation mapper 522b.

The operation of the transform module 52 is performed like as the flowchart shown in FIG. 4.

As described above, the secure policy description method and apparatus according to the certain embodiment of the present invention simply describes the secure policy of SELinux through the secure policy template and transforms the described secure policy template to the TE secure policy to be applied to the SELinux. Compared to the conventional SELinux secure policy setting method, the number of types and rules is significantly reduced, thereby removing the complexity of the secure policy. Also, a user having no expert knowledge is enabled to easily set and control a secure policy. Furthermore, the user defined security policy is automatically transformed to the TE secure policy in order to apply the user defined secure policy to the SELinux, thereby providing stable secure policy setting. Therefore, the usability of the secure operation system increases.

While the present invention has been shown and described in connection with the preferred embodiments, it will be apparent to those skilled in the art that modifications and variations can be made without departing from the spirit and scope of the invention as defined by the appended claims.

What is claimed is:

1. A secure policy description method for a secure operating system, the method comprising:
defining a secure policy template formed of a subject, an object, and a permission assigned to the subject corresponding to the object; and
transforming the defined secure policy template to a TE (Type Enforcement) secure policy to be applied to a SELinux (Security Enhanced linux).

2. The secure policy description method according to claim 1, wherein the defining a secure policy template comprises:
describing a template name to identify a secure policy template;
describing a subject element as a low level element of the secure policy template to define a subject accessing an object;
describing an object element as a low level element of the secure policy template to define at least one of objects as a target to access by the subject defined in the subject element; and
describing a permission element to define an access permission between the subject and the objects, which are defined in the subject element and the object element.

3. The secure policy description method according to claim 2, wherein the defining a secure policy template further comprises describing at least one of transition elements defining domain transition.

4. The secure policy description method according to claim 2, wherein in the describing a subject element, a domain name of a corresponding subject and type information of the corresponding subject are described.

5. The secure policy description method according to claim 2, wherein in the describing an object element, types of objects to access by a subject defined in the subject element and information about objects having the defined types are described.

6. The secure policy description method according to claim 2, wherein in the describing a permission element, each of object type defined in the object element, object classes of each of the object type, at least one of operations given to the subject for the object type and the object class are described.

7. The secure policy description method according to claim 3, wherein in the describing a transition element, a domain to transit and an object type to be executed to transit the domain to a domain of the subject element are described.

8. The secure policy description method according to claim 4, wherein the type information of the corresponding subject is one of a binary representing execution of a predetermined application and a daemon representing a service performed as a daemon type.

9. The secure policy description method according to claim 5, wherein in the describing an object element, an option value is further described to represent whether a secure context of an object is forcedly allocated or not.

10. The secure policy description method according to claim 5, wherein in the information about the objects, path information to assign a path for a corresponding object is described if the corresponding object is a file or a directory, and a value representing a corresponding object is described if the corresponding object is not a file or a directory.

11. The secure policy description method according to anyone of claims 5 to 7, wherein the object type or the object class is defined by grouping a plurality of object types or classes of objects defined in a SELinux based on a related permission in consideration of relativity and seriality.

12. The secure policy description method according to claim 6, wherein the operations of the permission element are defined by grouping the permission defined in a SELinux through analyzing relativity and seriality.

13. The secure policy description method according to claim 2, wherein the transforming the defined secure policy template to the TE secure policy comprises:
generating a domain with reference to the subject element of the secure policy template;
generating a type of an object by parsing the object element of the secure policy template;
generating a TE (Type Enforcement) operation by parsing the permission element of the secure policy template; and
generating a secure context of a TE policy by combining the generated type of an object and TE operation.

14. The secure policy description method according to claim 13, wherein the transforming the defined secure policy template to the TE secure policy further comprise generating domain transition by parsing the transition element of the secure policy template.

15. The secure policy description method according to claim 13, wherein in the generating the TE operation, permission sets of a SELinux are confirmed corresponding to an operation defined in the permission element through a mapping file that maps a set of permissions defined in the SELinux corresponding to permissions of a secure policy template, and the TE operation is generated using the confirmed permission sets.

16. A secure policy description apparatus comprising:
a secure policy template constituted as a form to set a subject, an object, and a permission assigned to the subject for the object; and
a transform module for transforming the secure policy template to a TE (Type Enforcement) secure policy to be applied to a SELinux (Security enhanced Linux).

17. The secure policy description apparatus according to claim 16, wherein the secure policy template comprises low level elements including a subject element for defining a subject accessing an object, an object element for defining at least one of objects as a target to access by the subject defined in the subject element, and a permission element for defining an access permission between the subject and the objects, which are defined in the subject element and the object element.

18. The secure policy description apparatus according to claim 17, wherein the secure policy template further comprises at least one of transition elements for defining domain transition.

19. The secure policy description apparatus according to claim 17, wherein the subject element is formed of a domain name denoting a corresponding subject and a type of the corresponding subject.

20. The secure policy description apparatus according to claim 17, wherein the object element is formed of types of objects accessed by the subject defined in the subject element and information about objects having the defined types.

21. The secure policy description apparatus according to claim 17, wherein the permission element comprises each object type defined in the object element, object class per the object type, and at least one of operations given to the subject for the object type and the object class.

22. The secure policy description apparatus according to claim 18, wherein the transition element comprises a domain to transit and an object type to be executed to transit the domain to a domain of the subject element.

23. The secure policy description apparatus according to claim 19, wherein the type of the corresponding subject is one of a binary representing the execution of a generic application and a daemon representing a service performed as a daemon type.

24. The secure policy description apparatus according to claim 20, wherein the object element further comprises an option value denoting whether a secure context is forcedly allocated to an object or not.

25. The secure policy description apparatus according to claim 20, wherein the information about the objects is a path assigning a path for a corresponding object if the corresponding object is a file or a directory, or is a value denoting a corresponding object if the corresponding object is not a file or a directory.

26. The secure policy description apparatus according to anyone of claims 19 to 21, wherein the object type or the object class is defined by grouping a plurality of object types or classes of objects defined in a SELinux based on a related permission in consideration of relativity and seriality.

27. The secure policy description apparatus according to claim 20, wherein an operation of the permission element is defined by grouping the permissions defined in a SELinux through analyzing relativity and seriality.

28. The secure policy description apparatus according to claim 18, wherein the transform module comprises:
a parsing unit for parsing the secure policy template; and
a generating unit for generating at least one of a subject domain, domain transition, an object type, and a TE operation from the parsed data, and generating a TE context by combining the generated subject domain, domain transition, an object type, or TE operation.

29. The secure policy description apparatus according to claim 28, wherein the parsing unit comprises:
a detector for detecting whether an object element, a transition element, and a permission element are present in the secure policy template as low level elements or not; and
a parser for parsing each of the low level elements if the detector determines that the low level elements are present in the secure policy template.

30. The secure policy description apparatus according to claim 28, wherein the generating unit comprises:
a type generator for generating a domain denoting a subject type and an object type;
an operation mapper for mapping operations definable in the secure policy template and permissions of a TE policy, receiving an operation parsed from a permission element of a secure policy template and a corresponding object type from the parsing unit, and returning a permission set of a corresponding TE policy;
a TE generator for generating a TE secure context by combining the domain and the object type which are generated from the type generator, and the permission set returned from the operation mapper.
